(19) United States
(12) Patent Application Publication
(10) Pub. No.: US 2006/0026615 A1
(43) Pub. Date: Feb. 2, 2006

(54) Information processing appliance

(76) Inventor: Yukio Sugimura, Yokohama-shi (JP)

Correspondence Address: NATH & ASSOCIATES, 1030 15th STREET, NW, 6TH FLOOR, WASHINGTON, DC, 20005, US

(21) Appl. No.: 11/177,298

(22) Filed: Jul. 11, 2005

(30) Foreign Application Priority Data
Jul. 30, 2004 (JP) P2004-223315

(51) Int. Cl. G11B 7/08

(52) U.S. Cl. 720/658

(57) ABSTRACT

The present invention provides an information processing appliance that is able to prevent a recording medium thereof from experiencing an excessive impact shock, thereby acquiring a high reliability. In the information processing appliance, a cartridge containing a recording medium is inserted into or removed out from a housing portion for housing the cartridge. The housing portion is separably provided inside the body unit and is supported in a floating manner or a rather rigid manner against the body unit by a buffer member disposed between the housing portion and the body unit. The information processing appliance further comprises a lock mechanism that supports the housing portion either in the floating manner when the cartridge is mounted therein or in the rather rigid manner when the cartridge is removed therefrom.

### BACKGROUND OF THE INVENTION

1. Field of the Invention

The present invention relates to an information processing appliance, specifically, such an information processing appliance that records or reads data on or from a recording medium housed in a detachable cartridge.

2. Description of the Related Art

In an information processing appliance such as a digital camera, a video camera, a note type personal computer, a portable music player, a personal digital assistance, or the like, a hard disc drive (HDD) utilizing a hard disc having a diameter of as small as one inch has come to be generally used as a detachable recording medium for such an information processing appliance, in addition to a conventional memory card including a compact flash (registered trademark) card. One example includes a micro drive (registered trademark) compatible to a compact flash card.

Such a cartridge enjoys a plentiful storage capacity due to a built-in HDD so that is preferably used to record or play a moving image requiring a large amount of data. As an example of such an information processing appliance is cited a digital camera disclosed in Japanese Patent Application Publication No. 2002-369121.

By the way, while the HDD-carrying cartridge is fully downsized, it is well known that such a cartridge has to be handled with care to keep the cartridge away from an impact shock or vibration applied thereon during its operation (Refer to Japanese Patent Application Publications Nos. 2002-369121 and 2003-297068 (for example the paragraph 0004 and so on)).

This is because of its construction in which a head mechanism for recording or reading data on or from the hard disc has to be floated at the time of operation whilst the mechanism is secured stationary at the time of non-operation.

Especially, an impact shock having a predetermined force or higher should be strictly avoided in the information processing appliance utilizing such a cartridge because such an impact shock may damage the HDD built-in in the cartridge.

In concrete terms, a permissible value of an impact shock applied on a larger face of the cartridge is estimated as 2000 G or lower at the time of idle and as 200 G or lower at the time of operation. Therefore, an information processing appliance of such a type requires anti-shock performance complying with such estimation.

By the way, since the cartridge is so small that the information processing appliance utilizing such a cartridge can be downsized, the appliance is easily handled. This may a disadvantage from a different viewpoint because an easy-to-handle appliance can be handled carelessly so that the cartridge may accidentally drop on a floor or hit a wall. As a result, the appliance and its cartridge may experience a strong impact shock.

From measurements carried out, it has been found that such an appliance experiences an acceleration of 2000 G when a user uses the appliance in a casual manner. Therefore, unless some measures are taken to acquire an above-mentioned anti-shock performance, the HDD housed in the cartridge may be broken, thereby deteriorating reliabilities of an information processing appliance.

### SUMMARY OF THE INVENTION

Under these circumstances, the objective of the present invention lies in a provision of an information processing appliance having a high reliability that is capable of preventing a built-in cartridge from experiencing an excessive impact shock.

In order to realize the objective, the present invention comprises as follows.

A first aspect of the present invention provides an information processing appliance (500) in which a cartridge (20) containing a recording medium (20h) can be inserted in or removed out through an opening (18a) provided in a body unit (500B) and thus information is recorded on or read from said recording medium (20h) of said cartridge (20) inserted. The information processing appliance (500) comprises a housing portion (18) separably provided inside of said body unit (500B), said housing portion (18) housing said cartridge (20), a first support member (25) supporting said housing portion (18) allowing for a first permissible amount in a relative position of said housing portion (18) with respect to said body unit (500B), a second support member (26b) supporting said housing portion (18) allowing for a second permissible amount or lower in a relative position of said housing portion (18) with respect to said body unit (500B), said second permissible amount being smaller than said first permissible amount, and a switching mechanism (27b) switching between said first support member (25) and said second support member (26b) to support said housing portion (18), thereby changing between said first permissible amount and said second permissible amount in said relative position.

A second aspect of the present invention provides an information processing appliance (500) according to the first aspect, wherein said first support member (25) is a buffer member (25) disposed between said housing portion (18) and said body unit (500B) and wherein said second support member (26b) is a connection member (26b) joining said housing portion (18) and said body unit (500B) restrictingly.

A third aspect of the present invention provides an information processing appliance (500) according to the first aspect, wherein said switching mechanism (27b) comprises a cartridge restricting member (7) restricting an insertion/removal of said cartridge (20) with respect to said opening (18a) when selecting said first support member (25).

A fourth aspect of the present invention provides an information processing appliance (500) according to the first aspect. The information processing appliance (500) further comprises an insertion/removal detector (29, 30a, 30b) detecting an insertion/removal of said cartridge (20) into/from said housing portion (18) to output a signal accordingly and a controller (15a, 30) controlling said switching mechanism (27b) based on the signal outputted from said insertion/removal detector.

A fifth aspect of the present invention provides an information processing appliance (500) according to the third aspect, wherein said cartridge restricting member (7) is a cover (7) that is openable and closable with respect to said opening (18a).

A sixth aspect of the present invention provides an information processing appliance (500) according to the second aspect, wherein said buffer member (25) has at least a pair of opposing faces, one face being attached on said housing portion (18) and the other face being attached on said body unit (500B) so as to absorb forces exerted in a compression and a shear direction due to a relative movement between said housing portion (18) and said body unit (500B) when the housing portion (18) is supported by the first support member (25).

A seventh aspect of an information processing appliance (500) according to the first aspect, wherein said recording medium (20h) is a hard disc.

According to the present invention, the cartridge is prevented from experiencing an excessive impact shock exerted from outside and being damaged, thereby acquiring a high reliability.

### BRIEF DESCRIPTION OF THE DRAWINGS

In the accompanying drawings:

FIG. 1 is a perspective view of an information processing appliance according to the present invention;

FIG. 2 is another perspective view of the information processing appliance according to the present invention;

FIG. 3 is an explanatory view of the inside structure of the information processing appliance according to the present invention;

FIG. 4 is a perspective view of a cartridge mounted in the information processing appliance according to the present invention;

FIG. 5 is a perspective view of a recording medium housing of the information processing appliance according to the present invention;

FIG. 6 is another perspective view of the recording medium housing of the information processing appliance according to the present invention;

FIG. 7 is an assembling drawing of the recording medium housing;

FIG. 8 is a perspective view of a slot portion of the information processing appliance according to the present invention;

FIG. 9 is another perspective view of the slot portion of the information processing appliance according to the present invention;

FIG. 10 is a plane view of a slot lock mechanism of the information processing appliance according to the present invention;

FIG. 11 is a plane view of a substantial part of a slot lock mechanism of the information processing appliance according to the present invention;

FIGS. 12A and 12B are an explanatory partial perspective view of a first and a second support state in the information processing appliance according to the present invention;

FIG. 13 is a perspective view of a switching mechanism of the information processing appliance according to the present invention;

FIG. 14 is an explanatory view of a modification of the information processing appliance according to the present invention;

FIG. 15 is a first explanatory view of another modification of the information processing appliance according to the present invention;

FIG. 16 is a second explanatory view of the another modification of the information processing appliance according to the present invention;

FIG. 17 is a third explanatory view of the another modification of the information processing appliance according to the present invention; and

FIGS. 18A and 18B each are a perspective view of yet another modification of the information processing appliance according to the present invention.

### DESCRIPTION OF THE PREFERRED EMBODIMENTS

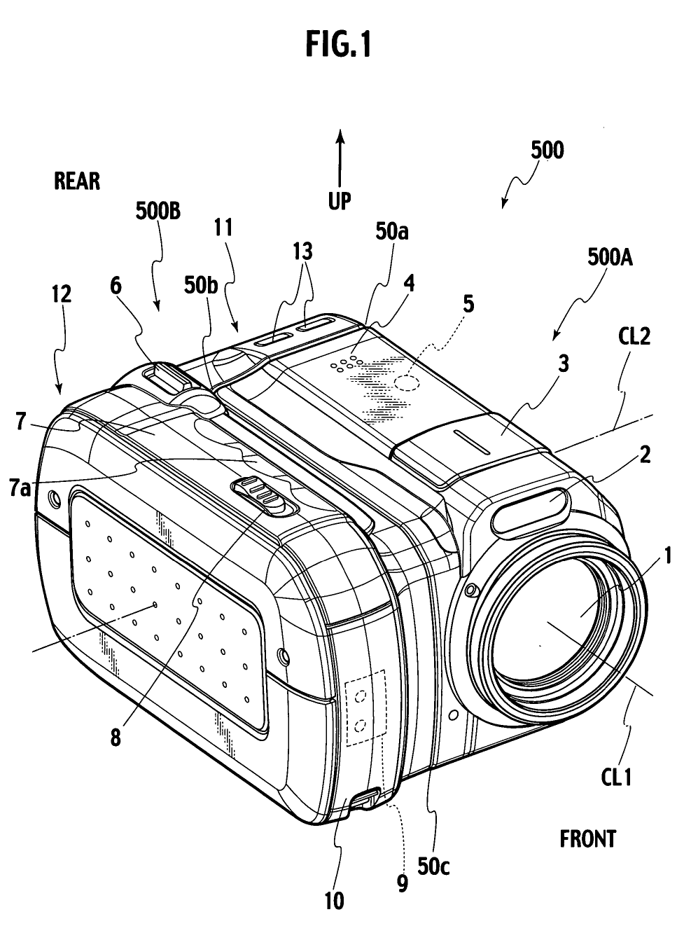

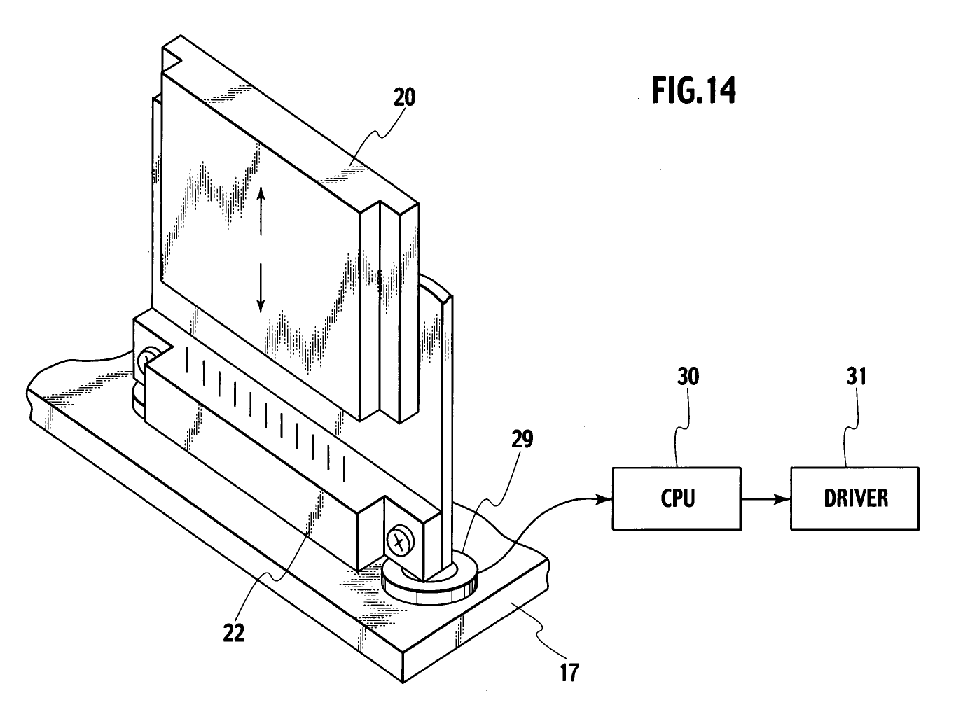

Preferred embodiments along with modifications according to the present invention will be described referring to FIGS. 1 to 18 hereinafter.

An information processing appliance according to the present invention is embodied into a vide camera in this embodiment, a schematic view of which is illustrated in FIG. 1.

A vide camera 500 (referred to as appliance 500 when appropriate) is mainly composed of a lens unit 500A and an L-shaped body unit 500B.

The two units each are an individual member that can separate from each other along a line connecting points 50a, 50b, and 50c. The lens unit 500A has a pivot mechanism (not shown) that allows the lens unit 500A to pivot around a pivot axis CL2 within a predetermined range of angle.

The lens unit 500A is comprised of a zoom lens 1 having an optical axis CL1, an electric flash 2, a stereo microphone 3, a speaker 4, a first group of operation switches 5 provided on a right side wall thereof and a first slot portion (not shown) provided on a bottom face. The first slot portion houses a memory card.

The body unit 500B is comprised of a zoom adjustor lever 6, a hinge flip cover 7, a lock lever 8, a group of connector terminals 9, a terminal cover 10 that conceals the group of connector terminals 9, a liquid crystal display (LCD) 11, a second group of operation switches 12 and a third group of operation switches 13. The hinge flip cover 7 has a concave portion 7a suitable to be gripped by fingers of a user when he or she holds the video camera 500.

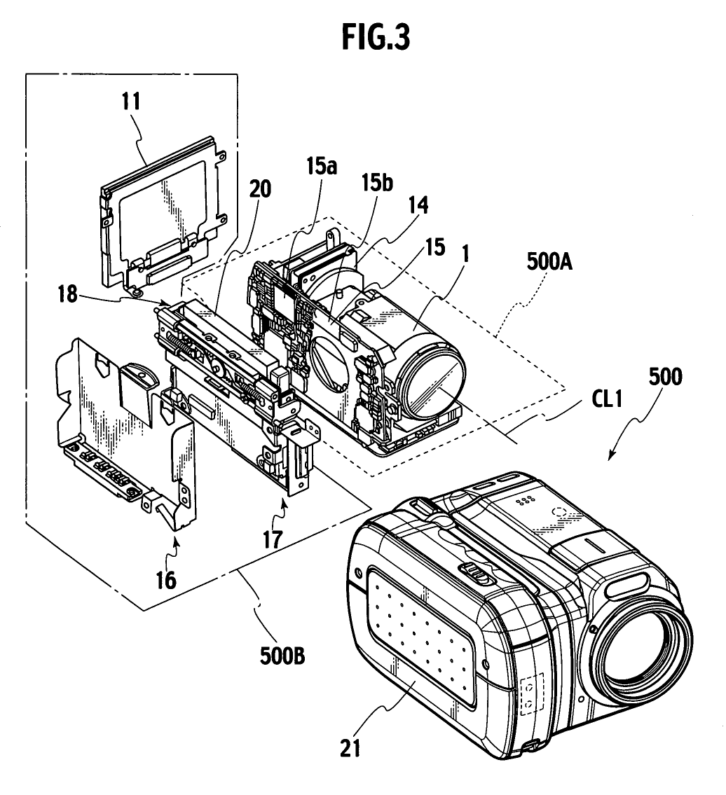

An internal configuration of the video camera 500 will be described in reference with FIG. 3. FIG. 3 illustrates an external appearance of the video camera 500, the view corresponding to FIG. 1, and a view of each block that constitutes the video camera 500 for easy understanding.

In FIG. 3, the lens unit 500A has the zoom lens 1, an image pickup device 14 converting image into an electric signal, the image pickup device being arranged behind the zoom lens 1, a substrate 15 on which an image processing circuit 15b is mounted, the substrate 15 being arranged beneath and left to the zoom lens 1 and the device 14, and a first slot portion (not shown) arranged below the device 14. On the substrate 15 is mounted a central processing unit (CPU) 15a that controls an entire operation of the video camera 500.

On the other hand, the body unit 500B is constituted with the LCD 11 arranged in a rear portion thereof, a battery housing 16 and a recording media housing 17 arranged substantially parallel with the optical axis CL1, all of which are covered with an exterior cover 21.

In FIG. 3, the recording media housing 17 has a second slot portion 18 into which a cartridge 20 (described later) has been inserted.

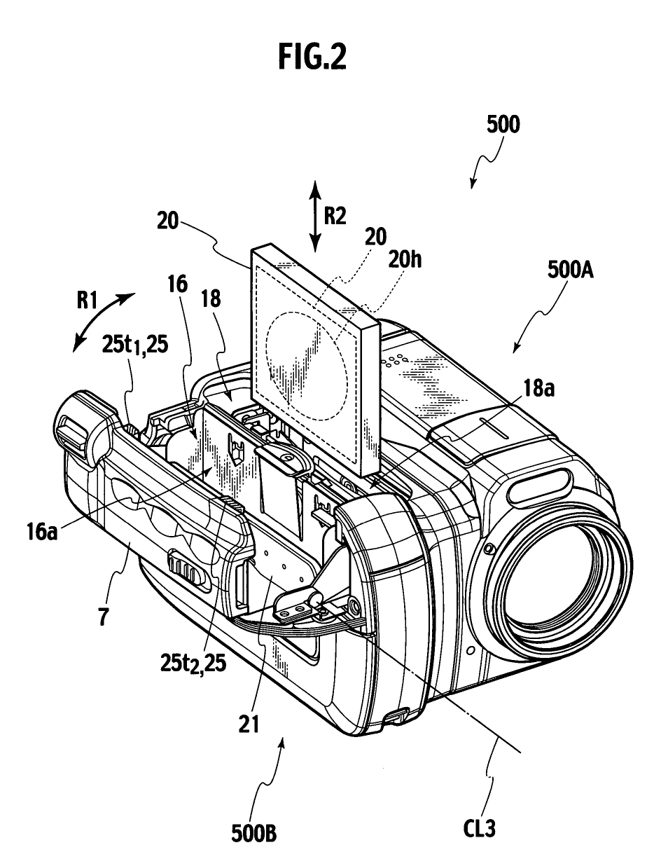

Referring back to FIG. 1, the hinge flip cover (cartridge restricting member) 7 can be opened by sliding the lock lever 8 to unlock a locking mechanism (not shown) so that an opening 18a (FIG. 2) of the second slot portion 18 and an opening 16a (FIG. 2) through which a battery (not shown) is set or removed are visible from above of the video camera 500.

Namely, the video camera 500 is configured so that the cartridge 20 and the battery are mounted from above of the video camera 500 by opening the hinge flip cover 7.

FIG. 2 illustrates the video camera 500 having the hinge flip cover 7 open in contrast with FIG. 1.

The hinge flip cover 7 is engaged with a shaft (not shown) provided on a pivot axis CL3 of the exterior cover 21. The hinge flip cover 7 is pivotable (R1) around the pivot axis CL3.

When the hinge flip cover 7 is open, the cartridge 20 can be inserted or removed in an UP/DOWN direction (an arrow R2 in FIG. 2) in relation to the opening 18a.

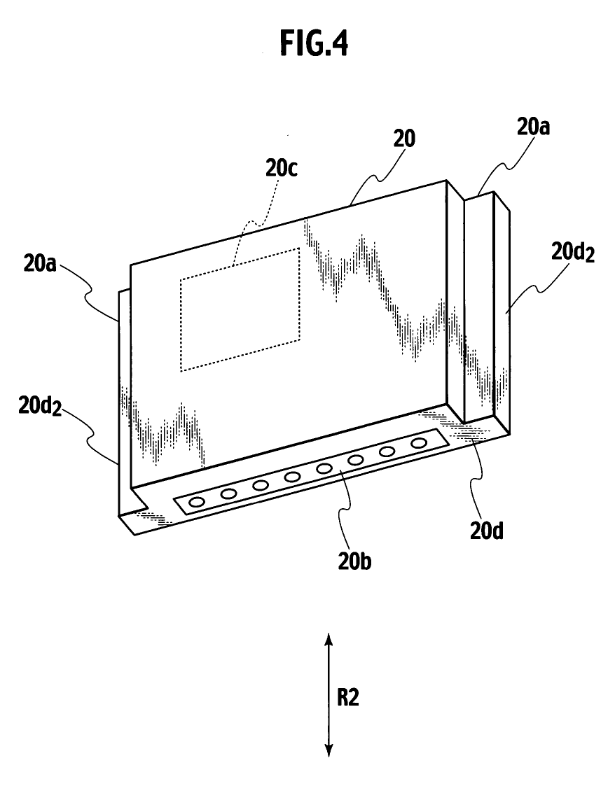

The cartridge 20 will be described referring to FIG. 4 that illustrates its external appearance.

The cartridge 20 has substantially a flattened rectangular parallelepiped shape and incorporates a hard disc drive (HDD) 20c using a hard disc, as a recording medium 20h.

The cartridge 20 is provided with a female connector 20b on one side face portion 20d of the cartridge 20, the connector 20b being used for signal exchanges between the HDD 20c and an external circuit.

The female connector 20b can be inserted into or removed from a male connector (described later) of the appliance 500 in an insertion/removal direction (R2 in FIG. 2). In other side face portions 20d2, 20d2 that oppose each other, there are formed a step portion 20a extending along the R2 direction.

The step 20a is fitted with a guide portion provided in the second slot portion 18 of the appliance 500, serving as a guide allowing a smooth insertion/removal of the cartridge 20.

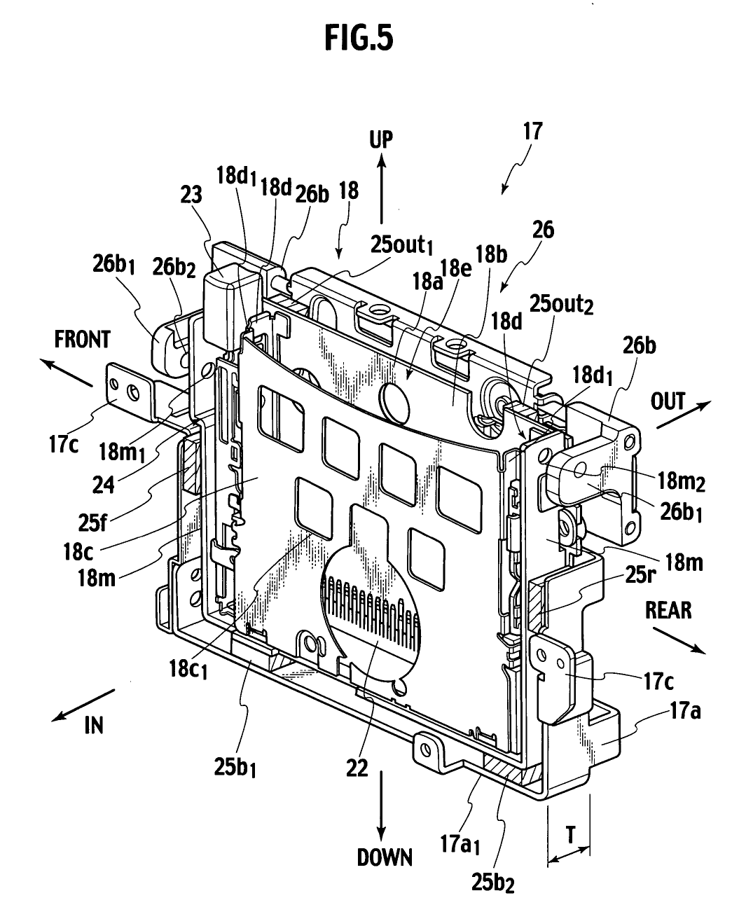

The recording medium housing 17 that houses the cartridge 20 will be described in detail referring to FIGS. 5 to 7.

FIG. 5 is a perspective view of the recording medium housing 17 seen from obliquely behind, illustrating mainly a side that faces the lens unit 500A.

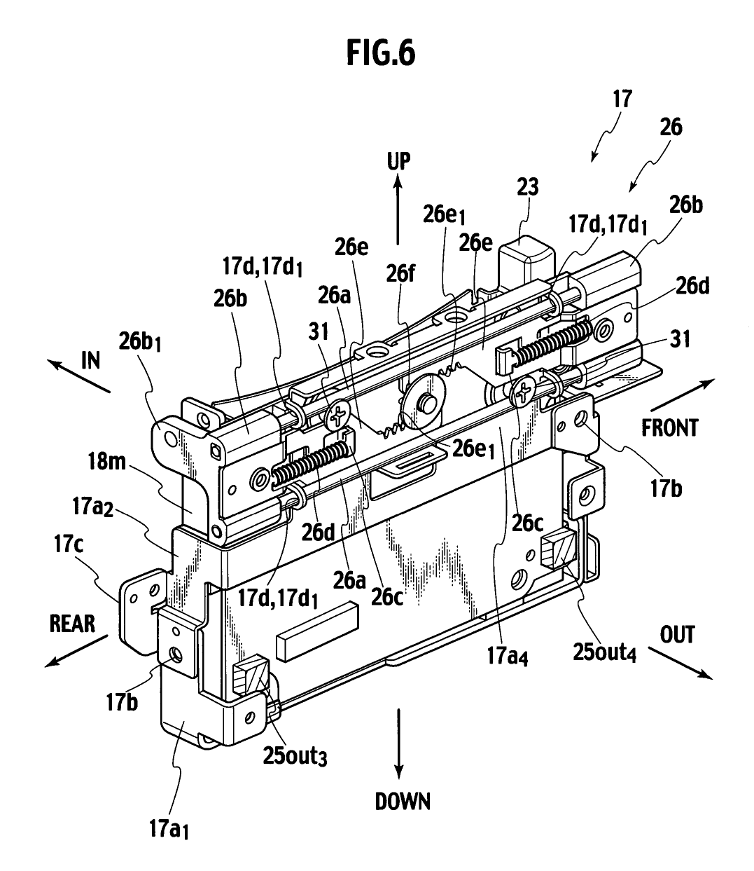

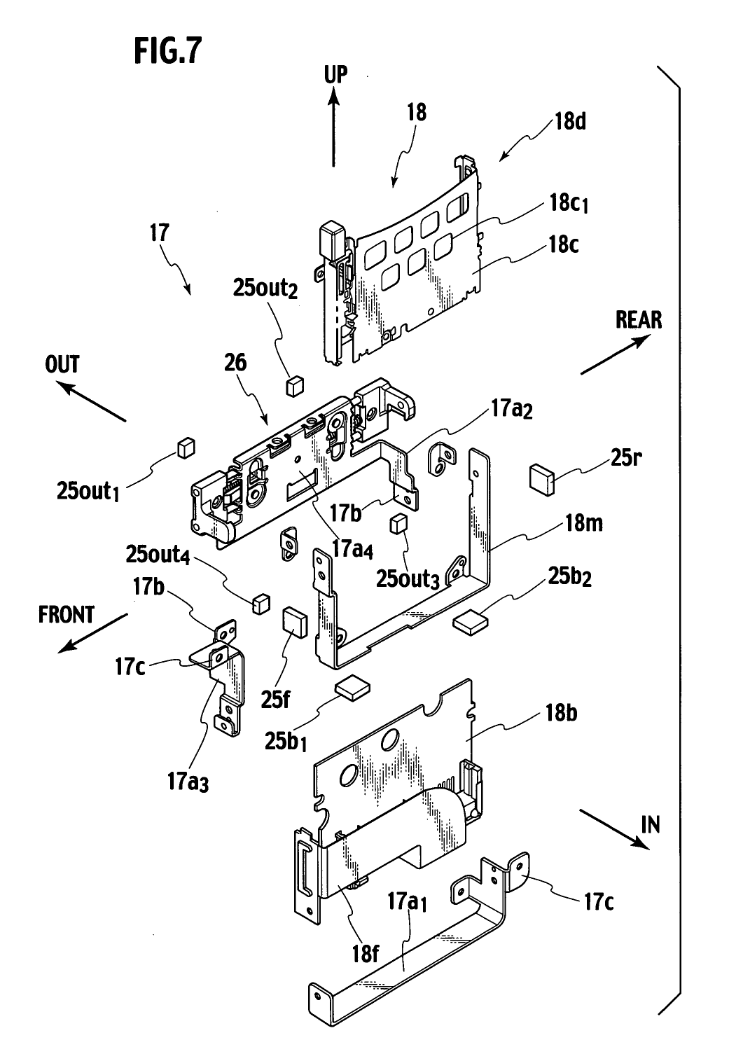

FIG. 6 is a perspective view of the recording medium housing 17 seen from obliquely behind, illustrating mainly a side that faces the battery housing 16. FIG. 7 is an exploded perspective view.

In FIGS. 5 to 7, a REAR, a FRONT, an IN and an OUT direction shown by each arrow are provided in order to make understood a relative position of the recording medium housing 17 with respect to the video camera 500.

The recording medium housing 17 has a base frame 17a that has been shaped into substantially a frame shape having substantially a width of T by pressing and forming a thin metal sheet as a starting material. The recording medium housing 17 is composed by joining a first frame 17a1, a second frame 17a2, and a third frame 17a3.

The first frame 17a1 is formed into substantially a U-shape, being disposed so as to be a lower face of the recording medium housing 17.

The second frame 17a2 has a wide portion 17a4 supporting a slot lock mechanism 26 (described later). The first frame 17a1, the second frame 17a2, and the third frame 17a3 are joined all together by a screw (not shown) penetrating two fastening portions 17b, 17b.

The base frame 17a has two lobe portions 17c, 17c extending along the FRONT/REAR direction. The lobe portions 17c, 17c and the body unit 500B of the video camera 500 are threadably combined with each other to be integrated.

The second slot portion 18 (referred to as slot portion 18 hereinafter) has substantially a U-shaped main frame 18m having an open upper end and a main plate 18b composed of a print substrate fastened o the main frame 18m. The main frame 18m is formed of metal.

The main plate 18b, a back plate 18c that opposes the main plate 18b and is formed of a thin metal sheet having a plurality of weight reducing holes 18c1 for making the back plate 18c lightweight, and a pair of side plates 18d, 18d disposed between the main plate 18b and the back plate 18c configures a housing portion 18e having a shape of substantially a flattened rectangular envelope.

The side plate 18d includes a guide portion 18d1 that fits with the step portion 20a of the cartridge 20 and the guide portion 18d1 serves to guide the step portion 20a when the cartridge 20 is inserted or removed.

A deeper portion (lower portion) of the housing portion 18e is provided with a male connector 22 fixated on the main plate 18b. The connector 22 is electrically connected with a wiring pattern provided on the main plate 18 and then with the substrate 15 (FIG. 3) of the video camera 500 via a flexible substrate 18f (FIG. 7).

In FIG. 5, a part of the back plate 18c is circularly removed only for the purpose of easy understanding of the configuration of the male connector 22.

When the cartridge 20 is inserted into the opening 18a of the slot portion 18 configured above, the cartridge 20 is guided along the insertion direction with the step portion 20a thereof fitted with the guide portion 18d1 and thus housed in the slot portion 18.

When the cartridge 20 is pressed further down by a finger of a user, the female connector 20b is engaged and electrically connected with the male connector 22. As a result, the cartridge 20 becomes operable as a recording medium of the video camera 500 as an information processing appliance.

A side plate 18d in a rear end of the slot portion 18 is provided with a release mechanism 24 (not shown in detail) to be used when the cartridge 20 is removed from the male connector 22.

In the release mechanism 24, when the cartridge 20 is housed in the recording medium housing 17, a downward movement of a release lever 23 allows an arm (not shown) connected to the release lever 23 by a linkage mechanism to raise the cartridge 20 up until the female connector 20b is disconnected from the male connector 22. The cartridge 20 removed from the connector 22 can be taken away from the recording medium housing 17 by picking up the cartridge 20.

The mechanism 24 is able to work as above every time the cartridge 20 is removed therefrom, since the release mechanism 24 is re-set every time the cartridge 20 is inserted into the recording medium housing 17.

A structure for supporting the slot portion 18 in the recording medium housing 17 will be described in detail.

In the video camera 500 according to this embodiment, in order to prevent an excessive acceleration from being applied to the cartridge 20 by absorbing an impact or shock from outside, the slot portion 18 for housing the cartridge 20 is configured so that the body unit 500B and the recording medium housing 17 integrated with the body unit 500B support the slot portion 18 via a buffer member (a first support member) 25.

The structure will be described in detail referring to FIGS. 5 to 9.

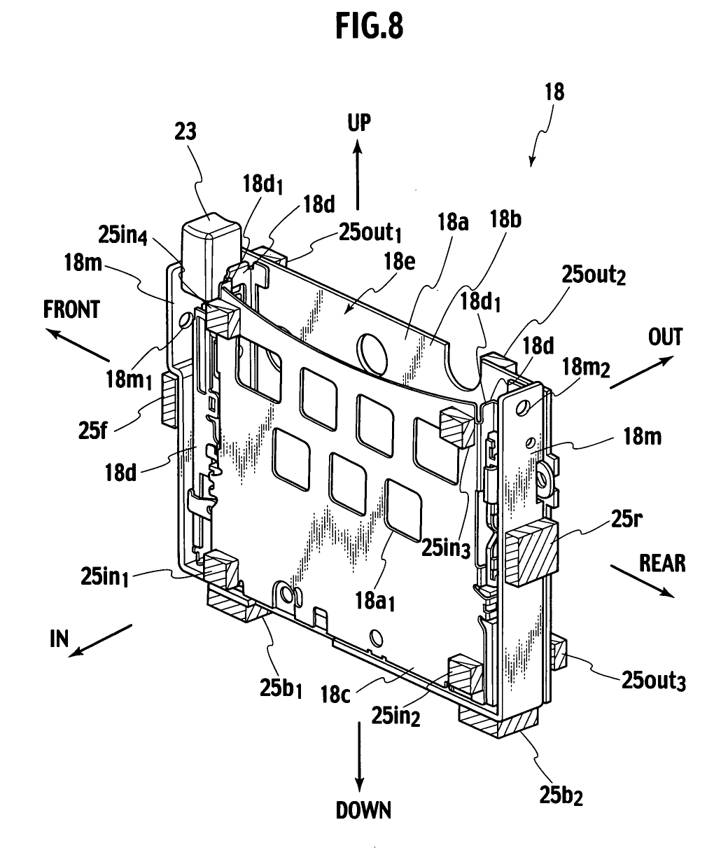

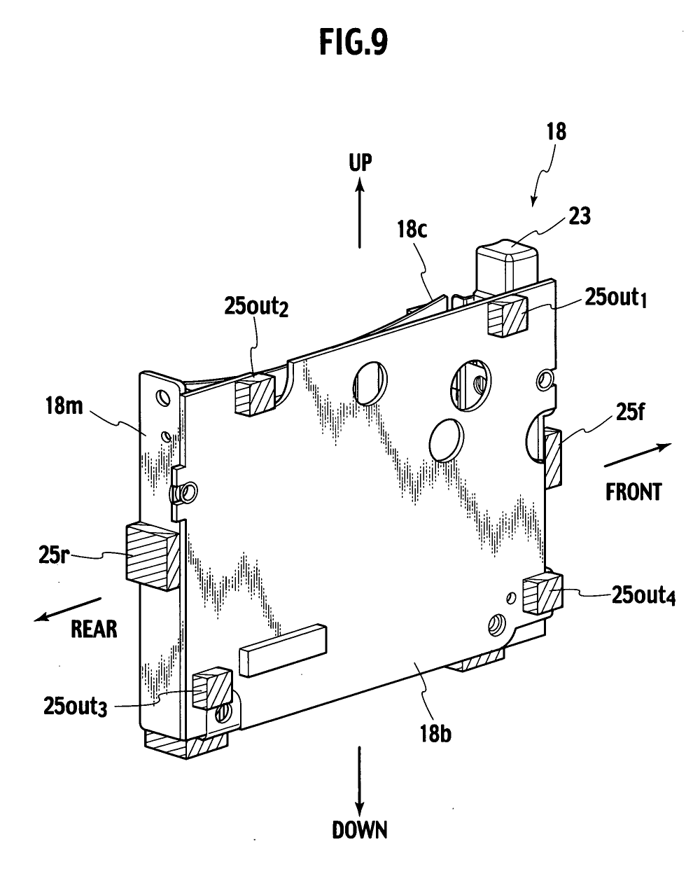

FIGS. 8 and 9 illustrate the slot portion 18 only, as is not the case with FIGS. 5 and 6.

First of all, regarding the IN direction in FIG. 8, four buffer members 25in1, 25in2, 25in3, and 25in4 each are attached on the vicinity of each of four corners of the back plate 18c as shown in FIG. 8 so as to lie between the back plate 18c and the body unit 500B.

Regarding the FRONT direction, a buffer member 25f lies between the main frame 18m and the base frame 17a. The buffer member 25f is attached on both frames 18m, 17a.

Regarding the REAR direction, a buffer member 25r lies between the main frame 18m and the base frame 17a. The buffer member 25r is attached on both frames 18m, 17a.

Regarding the OUT direction, four buffer members 25out1, 25out2, 25out3, and 25out4 each are attached in the vicinity of each of four corners of the main plate 18b.

Among these four buffer members, the upper two buffer members 25out1 and 25out2 are attached on a lock mechanism supporting portion 17a4 and the main plate 18b, respectively, so as to stay therebetween.

On the other hand, the lower two buffer members 25out3, 25out4 are attached on the main plate 18b and the body unit 500B so as to stay therebetween.

Regarding the DOWN direction, two buffer members 25b1 and 15b2 are attached on the main frame 18m and the base plate 17a, respectively, so as to stay therebetween.

Regarding the UP direction, two buffer members 25t1 and 25t2 are attached on an inner face of the hinge flip cover 7. These two buffer members 25t1 and 25t2 abut the upper face of the cartridge 20 when the cover 7 is closed. It should be noted that each buffer member having a different suffix may be referred to collectively as a buffer member 25 hereinafter.

By the way, the buffer member 25 is attached preferably using a double-sided adhesive tape. However, an adhesive agent, or the like can be used.

With the above configuration, the slot portion 18 for housing the cartridge 20 is supported against the body unit 500B of the video camera 500 only by buffer members 25.

In other words, since each buffer member 25 can deform in accordance with force exerted from outside so as to absorb the force, the slot portion 18 is practically floated or loosely supported so as to move in every direction in relation to the video camera 500 to some extent.

Namely, when the slot portion 18 is supported in such a way, a permissible amount in a relative position of the slot portion (housing portion) 18 for housing the cartridge 20 with respect to a body portion (the body unit 500B) of the video camera 500 is set to be larger compared with when the slot portion 18 is rigidly supported.

As the buffer member 25 is used a commercially available buffering material such as but not limited to rubber, elastmer, gel, which are all used for the purposes of shock absorbing. In order to downsize the appliance 500, the buffer member 25 is preferably thinner as far as a predetermined anti-shock performance is obtained. Under this circumstance, a so-called gel material having an excellent buffering performance is better used.

In the video camera 500 according to this embodiment, each buffer member 25 should preferably be 5 millimeters (mm) thick or less in order to miniaturize the camera 500 as much as possible, while ensuring a predetermined shock-absorbing performance. In other words, an impact shock caused on the cartridge 20 by a fall of 70 centimeters (cm) has to be 200 gravitational acceleration (G) or less.

In this embodiment, a low hardness gel material having a thickness of 2 to 3 mm and a contact area of 25 meters square (mm²) is used as the buffer member 25.

It is confirmed that this buffer member 25 satisfies the above shock-absorbing performance.

By the way, each face of the cartridge 20 has a different permissible value of impact shock. For example, a permissible value of impact shock exerted on the larger face of the cartridge has to be smaller than on the smaller face that constitutes a side face of the cartridge 20.

Therefore, the buffer member 25 that is to absorb an impact shock exerted on the larger face has to have a higher shock-absorbing performance.

For example, the buffer members 25 that are attached on the main and the back plate 18b, 18c can be larger or thicker.

In addition, the position of the buffer members 25 on the plate 18b, 18c, the number of the materials 25, and properties (elasticity, hardness or the like) of the materials 25 can be varied to optimize the shock-absorbing performance.

By the way, the buffer member is shaped of a rectangular parallelepiped, one face of which is attached on the slot portion 18 and the opposing face of which is attached on the body unit 500B. Therefore, the buffer member can absorb an impact shock exerted thereon in a direction perpendicular to the face thereof by its own contraction or expansion and in a direction parallel to the face thereof by its shear resistance.

In other words, the slot portion 18 is practically floated or loosely supported using both buffering action demonstrated by the contraction/expansion and by the shear resistance of the buffer member in this embodiment.

The buffer members 25f, 25r, 25b1, and 25b2 attached on a front face, a rear face, a front bottom portion, and a rear bottom portion, respectively, can exhibit buffer action by a shear resistance against the impact shock in the IN/OUT direction so that the four buffer members 25out1 to 25out4 attached on the main plate 18b and the other four buffer members 25in1 to 25in4 attached on the back plate 18c can be thinner. Therefore, the video camera 500 according to this embodiment is downsized in width (in a right to left direction).

On the other hand, the buffer members 25out1 to 25out4 attached on the main plate 18a and the buffer members 25in1 to 25in4 attached on the back plate 18c have a low hardness of 6 in a unit of JIS A and are made of a material excellent in vibration absorbing performance.

The buffer members 25f, 25r, 25b1, 25b2, 25t1, and 25t2 are made of a low hardness buffering material having a hardness of 80 in a unit of ASKER FP, which corresponds to about 8 in a unit of JIS A.

As described above, since the buffer members for absorbing an impact shock exerted along the IN/OUT direction has better vibration suppression than those for absorbing an impact shock exerted along the UP/DOWN or the FRONT/REAR direction, an impact shock applied to the main plate 18b and the back plate 18c having a lower permissible value is effectively absorbed.

By the way, it is known that low molecular weight siloxane vaporized from silicone rubber or adhesive agent can cause troubles in electrical contacts of switches or the like.

The buffering material may contain silicone and its compounds in order to have a suitable property as a buffering material.

Since the cartridge such as a microdrive mentioned above is not completely sealed, low molecular weight siloxane may have an adverse effect on the built-in HDD. In addition, since an information processing appliance has many switches for its operation, troubles in electrical contacts may occur by the chemical.

Therefore, the buffer member used is preferably made of non-silicone material that has no influence on electrical contacts.

As stated above, the cartridge 20 has the female connectors 20b for electrical connection on one face thereof and is mounted on and off the slot portion 18 by inserting the female connectors 20b in and out the male connectors 22 provided in the slot portion 18.

Therefore, the male connector 22 of the appliance 500 needs to be firmly supported so as to assure the electrical connection when the cartridge 22 is mounted and at the same time the connector 22 needs to be supported so as to allow prompt removal of the cartridge 20 when the cartridge 20 is removed.

Since the slot portion 18 is supported in a floating manner, it is not very easy to insert the cartridge 20 only by guiding the step portion 20a along the guide portion 18d1 when the cartridge 20 is inserted into the slot portion 18. Therefore, the cartridge 20 may not be inserted quickly.

In addition, there may arise a disadvantage in that the cartridge 20 is not removed easily, because the connector is not rigidly supported or because the cartridge 20 is shaky at the time of removal of the cartridge 20.

Furthermore, if the cartridge 20 is forced to be inserted into the slot portion 18, the connector 20b may be damaged, thereby deteriorating reliability.

The video camera 500 according to this embodiment has a configuration that can eliminate the above-mentioned possible disadvantages.

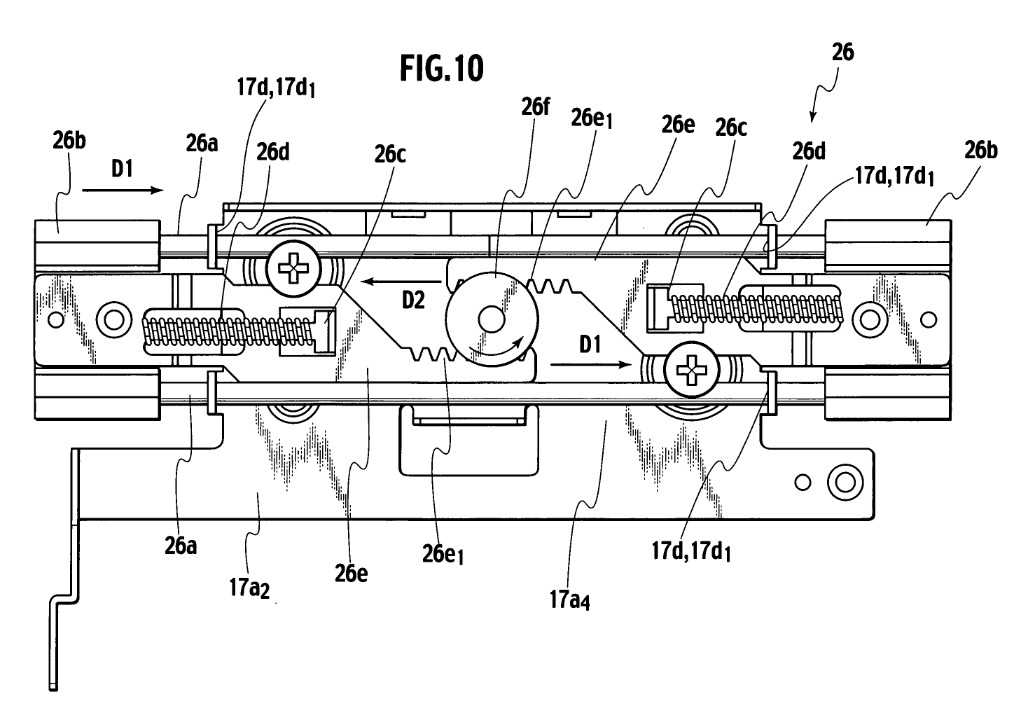

Referring to FIGS. 6 and 10, there will be described a slot lock mechanism 26 that makes it possible to insert the cartridge 20 in and out assuredly and easily.

The slot lock mechanism 26 is provided on a lock mechanism support portion 17a4 that is a wide portion of the second frame 17a2 of the recording medium housing 17.

The slot lock mechanism 26 is configured to have a pair of parallel shafts 26a, 26a each penetrating two shaft support holes 17d1, 17d1 each made in two protrusions 17d, 17d extending from the second frame 17a2, a pair of substantially an L-shaped lock plates (a second support member) 26b, 26b that receive an end portion of the shafts 26a, 26a and allows the shafts 26a, 26a to slide along the longitudinal direction thereof, a pair of spring support portions 26c, 26c that are formed by severing a part of the second frame 17a2 and raising the part, a pair of spring coils 26d, 26d, one end of which is connected to the spring support portion 26c and the other end of which is connected to the lock plate 26b, the spring coils biasing the lock plate 26b on both ends of the shaft 26a, a pair of rack boards 26e, 26e that are secured on one lock plate 26b and extends toward the other lock plate 26b, the pair of rack boards 26e, 26e having rack portions 26e1, 26e1 opposing laterally each other, and a gear 26f that is engaged with the pair of the rack portions 26e1, 26e1 and transmits a movement of one rack board 26e along the shaft 26a to cause the other rack board 26e to move in the opposite direction.

Therefore, one lock plate 26b and the other lock plate 26b move in the opposite direction with respect to each other.

In the slot lock mechanism 26, the shaft 26 is threadably secured on a lock mechanism support portion (wide portion) 17a4 using a flat-headed screw 31.

The lock plate 26b is made of metal such as but not limited to Aluminium.

The lock plate 26b is biased outward by a biasing force exerted thereon by the spring coil 26d. However, the lock plate 26b comes to halt in a predetermined position as shown in FIG. 10 by a positioning means (not shown). This situation shown in FIG. 10 is referred to as a first support state hereinafter.

Under the first support state, when the force that opposes the biasing force exerted from the spring coil 26d is applied on the left lock plate 26b in FIG. 10, for example, this lock plate 26b moves accordingly along the shaft 26a.

With this movement, the rack board 26e secured on the lock plate 26b also moves in the D1 direction in FIG. 10, thereby rotating in a counter-clock direction the gear 26f with which the rack portion 26e1 is engaged.

Then, the other (right) rack board 26e with which the gear 26f is engaged moves in the D2 direction, thereby shifting the other lock plate 26b on which this rack board 26e is secured in the D2 direction.

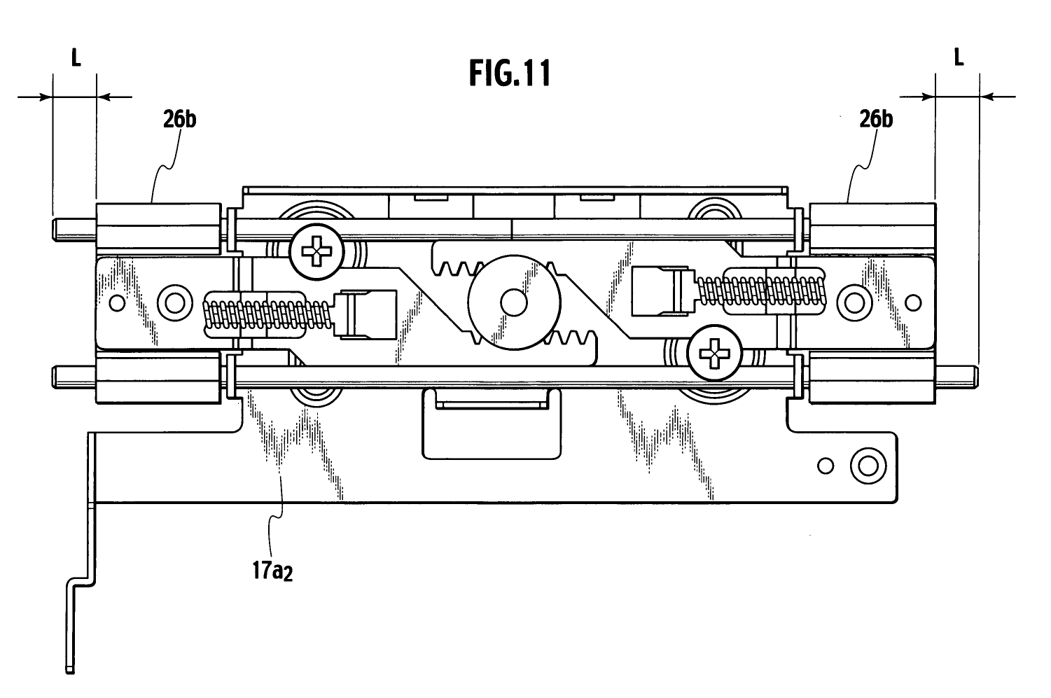

Due to this movement, both lock plates 26b, 26b come closer by a given distance of L as shown in FIG. 11. This situation as shown in FIG. 11 is referred to as a second support state hereinafter.

The lock plate 26b has an arm portion 26b1 extending from its body portion so as to form an L-shape and is engaged with the shaft 26a. On an inner face of the arm portion 26b1, a protrusion 26b2 is formed so as to extend in substantially a cone shape.

The protrusion 26b2 is configured so as to be engaged with lock holes 18m1, 18m2 provided on the main frame 18m.

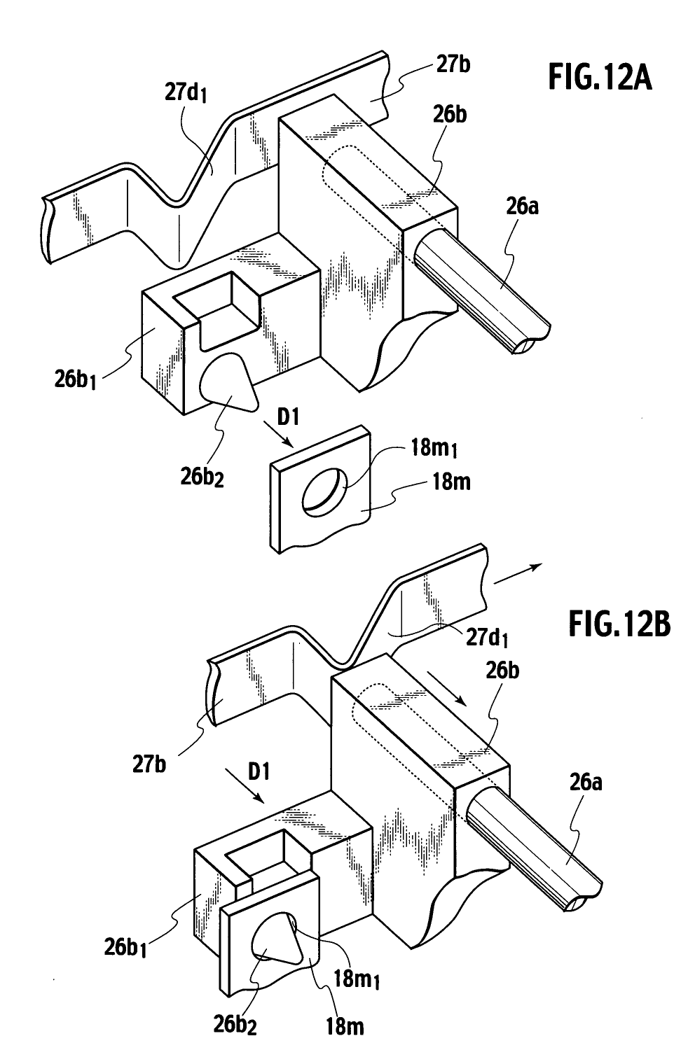

How the protrusion 26b2 is engaged with the lock holes 18m1, 18m2 will be described referring to FIGS. 12A and 12B.

FIGS. 12A and 12B are an enlarged perspective view of the vicinity of the arm portion 16b1 of the lock plate 26b and the lock hole 18m1 of the main frame 18m. The arm portion 16b1 and the lock hole 18m1 in FIG. 12 are those positioned near the front end of the recording medium housing 17 illustrated in FIG. 5. FIG. 12A illustrates the first support state. FIG. 12B illustrates the second support state.

As shown in FIG. 12A, the protrusion 26b2 is positioned away from the main frame 18m in the first support state. Therefore, the slot portion 18 is supported in a floating manner only by each buffer member 25.

On the other hand, in the second support state as shown in FIG. 12B, the lock plate 26b shifts along the shaft 26a in the D1 direction and thereby the protrusion 26b2 comes to an engagement with the lock hole 18m1 of the main frame 18m.

Therefore, the main frame 18m is restricted against the lock plate 26b and supported integrally and rigidly. In other words, the slot portion 18 and the body unit 500B come to be substantially integrated.

Therefore, when the cartridge 20 stays mounted in the video camera 500, the cartridge 20 is supported in a floating manner since the lock plate 26b takes the first support state. However, when the cartridge 20 is inserted or removed, the cartridge 20 is supported rigidly, because the lock plate 26b takes the second support state and thus the male connector 22 is not excessively shaky. As a result, the cartridge 20 can be inserted assuredly and smoothly, thereby preventing damage and connection failure in the connectors.

In addition, since the cartridge 20 does not excessively shake at the time of removal, the cartridge 20 can be easily pinched by fingers and thus removed easily and smoothly.

Whilst the second support state does not necessarily require that the slot portion 18 stay completely stationary with respect to the body unit 500B without leaving any allowance, the slot portion 18 is supported substantially rigidly in the second support state.

In other words, the cartridge 20 can move only slightly so that the connector 20b is inserted easily and securely. It is only required that when the cartridge 20 is inserted into the slot portion 18 the second support state enables the cartridge 20 to be restricted allowing for less shaky movement of the cartridge 20 compared with the first support state.

In summary, a permissible amount of shift in a relative position of the slot portion 18 for housing the cartridge 20 in relation to the body unit 500B of the video camera 500 is much smaller in the second support state than in the first support state.

The permissible amount of shift in the second support state is determined by the size of the protrusion 26b2 and the lock hole 18m1. Namely, the permissible amount corresponds to a clearance between a diameter of the protrusion 26b2 and an inner diameter of the lock hole 18m1 when the lock plate 26b stays in the second support state in which the protrusion 26b2 penetrates the lock hole 18m1.

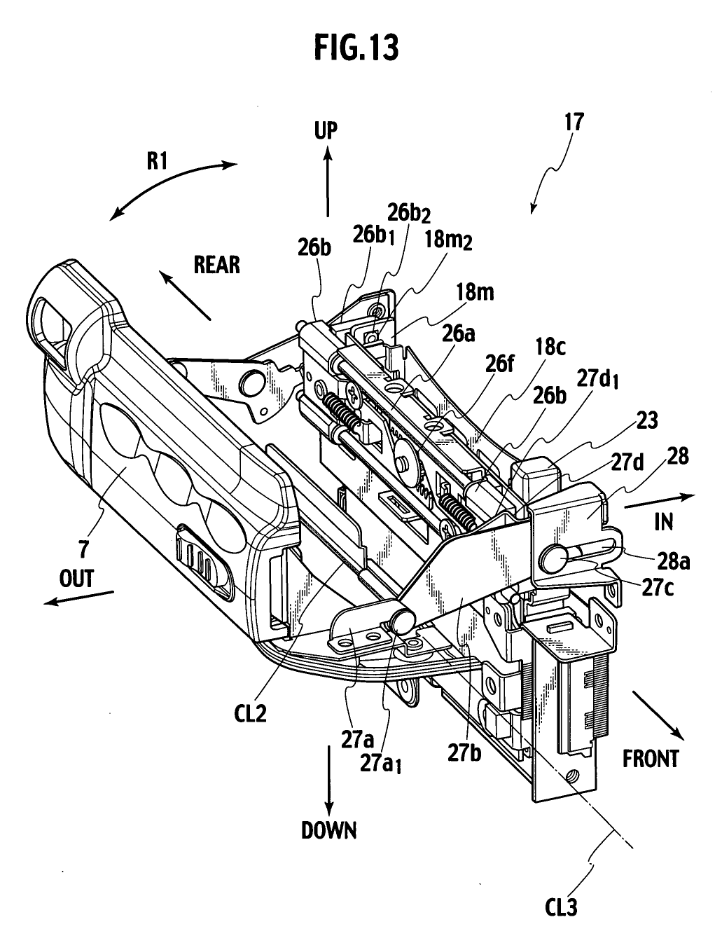

Next, how the first support state is switched to the second support state and conversely will be described referring to FIG. 13.

As described above, the second support state is realized at the time of inserting the cartridge 20. Switching between the two states are carried out by an open/close movement of the hinge flip cover 7 in this embodiment.

FIG. 13 illustrates the vicinity of the hinge flip cover 7 and the recording medium housing 17 shown is FIG. 2.

In this video camera 100, the cartridge 20 is inserted or removed after the hinge flip cover 7 is opened. The first support state is realized when the hinge flip cover 7 is closed, whilst the second support state is realized when the hinge flip cover 7 is opened.

Specifically, in an inner front portion of the hinge flip cover 7 is attached a hinge base portion 27a to which a hinge arm (switching mechanism) 27b is connected. The hinge arm 27b is pivotable around a fastening portion (pivot) 27a1.

There is provided a slide pin 27c at the front portion of the hinge arm 27b.

In a hinge guide 28 provided on the body unit 500B, there is provided a guide hole 28a having a shape of slit extending along the IN/OUT direction. With the guide hole 28a receives the slide pin 27c of the hinge arm 27b.

With this configuration, when the hinge flip cover 7 is pivoted around the pivot axis CL2 and closed, the slide pin 27c is guided along the guide hole 28a and thus the hinge arm 27b moves horizontally in the IN direction.

On the other hand, there is formed a slope portion 27d near the lock plate 26b and on the hinge arm 27b. The slope portion 27d is sloped so that a distance between a slope face 27d1 thereof and the hinge arm 27b increases gradually toward the IN direction.

When the hinge flip cover 7 is opened, the slope face 27d1 of the slope portion 27d abuts and moves the lock plate 26b in the REAR direction. As a result, the lock plate 26 comes to be in the second support state (see FIG. 12B).

When the hinge flip cover 7 is closed, the hinge arm 27 moves the slope portion 27d in the IN direction. Thus, the lock plate 26b slides in relation to the shaft 26a toward the FRONT direction by a biasing force exerted from the spring coil 26d. As a result, the lock plate 26b comes to stay away from the main frame 18m. In other words, the lock plate 26b comes to be in the first support state (see FIG. 12A).

In this embodiment, the first support state and the second support state are switched reciprocally depending on the opening/closing of the hinge flip cover 7.

By the way, the switching is not limited to the embodiment described above but can be altered.

For example, the following configuration is possible as a first modification. Namely, while there is provided on the base frame a pressure sensor 29 that detects a pressure exerted on the male connector 22 along the insertion/removal direction, the body unit 500B is provided with a central processing unit (CPU) 30 that determines whether the first support state or the second support state is realized based upon the signal from the pressure sensor 29 and thus outputs an instruction signal, and a driver 31 that shifts the lock plate 26b into the determined support state based upon the signal outputted from the CPU 30.

In this first modification, when the pressure sensor (insertion/removal detector) 29 detects a pressure of a predetermined value or higher, the sensor 29 determines that the cartridge 20 is being inserted or removed and thus the CPU 30 controls to shift the lock plate 26b into the second support state. When the pressure sensor 29 stops detecting the pressure, the CPU 30 realizes the first support state.

This modification is preferable when the hinge flip cover that covers the opening of the slot portion is not provided in an information processing appliance. Nothing to say that the CPU 15a mounted on the substrate 15 can be used instead of the CPU 30.

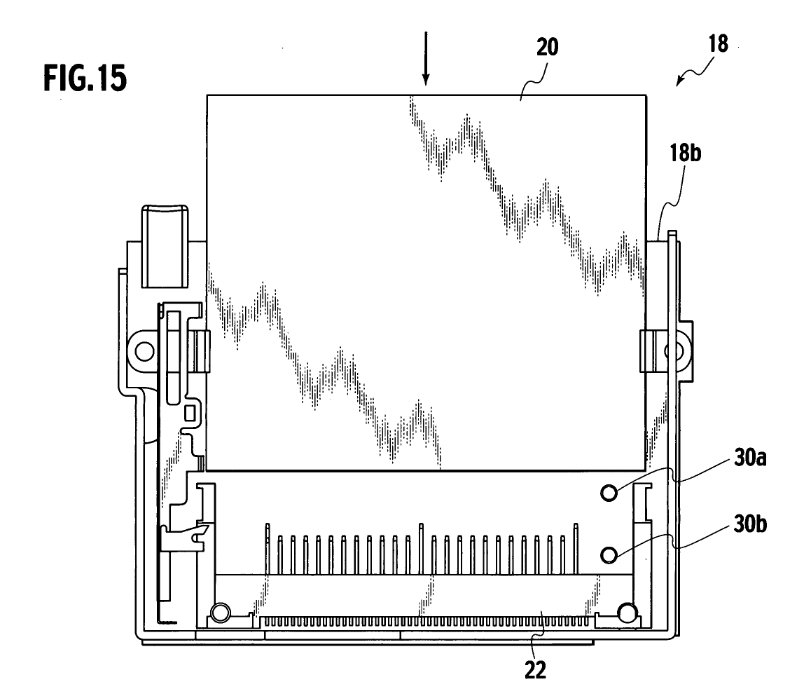

Next, a second modification will be described referring to FIGS. 15 to 17. This second modification has the CPU 30 (15a) and the driver 31 (not shown) as is the case with the first modification.

FIGS. 15 to 17 are a schematic side view of the slot portion 18, each illustrating a different position of the cartridge 20 along the direction shown by an arrow in the figures. In addition, the first support state is a norm in this modification.

FIG. 15 illustrates where the cartridge 20 is inserted halfway into the male connector 22.

In the second modification, there are provided a first position sensor 30a and a second position sensor 30b that are arranged on the main plate 18b as a substrate, leaving a predetermined distance therebetween. The sensors 30a, 30b transmit an output signal to the CPU 30 (15a).

In the configuration shown in FIG. 15, since the cartridge 20 stays away from the two position sensors 30a, 30b, no detection signal is transmitted.

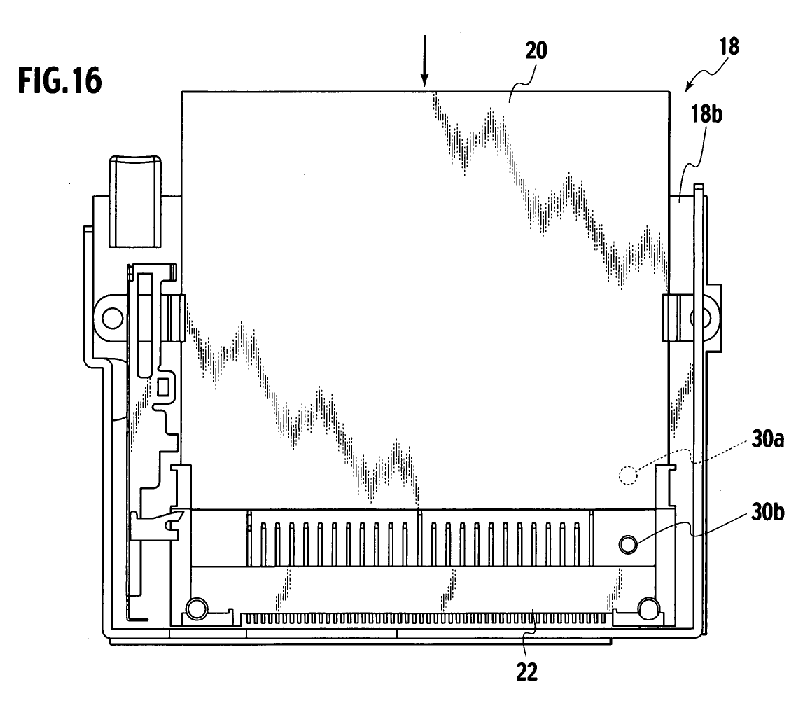

FIG. 16 illustrates where the cartridge 20 is pressed further down.

In this situation shown in FIG. 16, the cartridge 20 stays close enough to trigger the first position sensor 30a to output a detection signal.

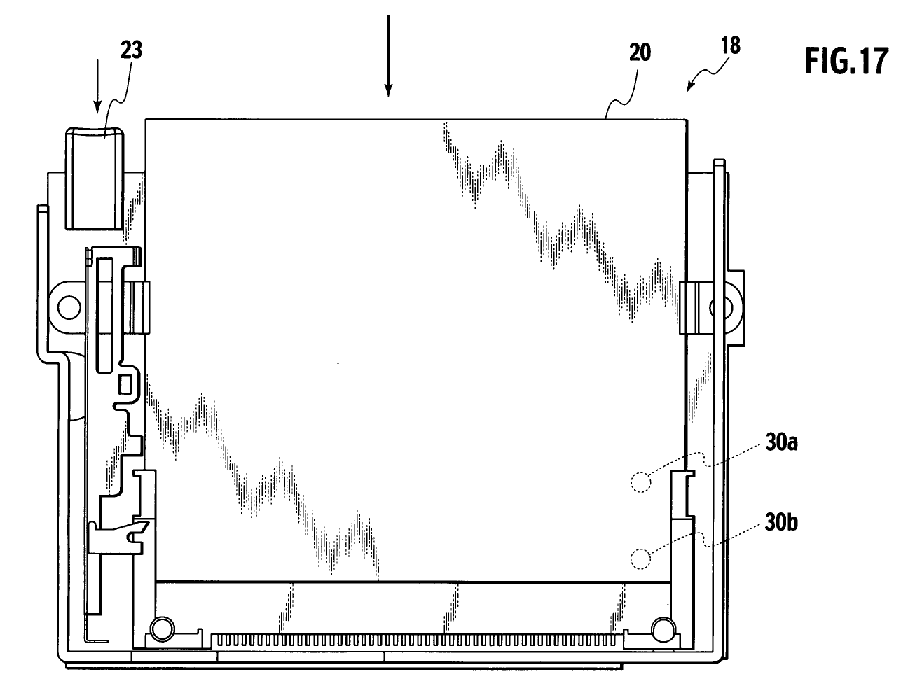

FIG. 17 illustrates where the cartridge 20 is pressed yet further down compared with that shown in FIG. 16 and the female connector 20b of the cartridge 20 is fully inserted into the male connector 22.

When the cartridge 20 is being moved from the position shown in FIG. 15 to that in FIG. 16, the cartridge 20 comes close to the second position sensor 30b and thus the sensor 30b as well as the sensor 30a outputs a detection signal.

Therefore, since the first position sensor 30a outputs the detection signal first and next the second position sensor 30b outputs the detection signal, the CPU 30 (15a) can determine that the cartridge 20 is being pressed down and allow the driver 31 to control the lock plate 26b into the second support state.

When the cartridge 20 is removed, the release lever 23 is pressed down in a direction shown by an arrow and thus the cartridge 20 is raised until the female connector of the cartridge 20 is removed from its mating connector provided in the slot portion 18. At this time, the cartridge 20 comes to assume a position again as shown in FIG. 16.

In this modification, there is provided a sensor (not shown) that detects depression movement of the release lever 23. When the sensor detects the movement, the CPU 30 (15a) determines that the cartridge 20 is being removed and allows the driver 31 to control the lock plate 26b accordingly.

After the cartridge 20 was mounted into the slot portion 18 of the video camera 500 (weighted of 320 grams with batteries included) according to the above-stated embodiment and the hinge flip cover 7 was closed, a drop test of 70 cm was carried out in order to measure an impact shock (acceleration G) exerted on the cartridge. The test was carried out six times, in each of which each one of six sides of the video camera hit the floor.

Since the cartridge 20 was mounted and the hinge flip cover 7 was closed, this drop test was carried out for the video camera 500 in which the first support state is realized. Specifically, the impact shock was measured with a small acceleration switch having a diameter of 2 mm attached on three different faces of the cartridge 20, the three different faces being orthogonal to one another.

The buffer members attached on the faces perpendicular to the FRONT/REAR direction have a thickness of 2 mm and their total area is about 30 mm². The buffer members attached on the faces perpendicular to the UP/DOWN direction have a thickness of 2 mm and their total area of about 60 mm².

On the other hand, the buffer members attached on the faces perpendicular to the IN/OUT direction have a thickness of 3 mm and their total area is about 30 mm².

By the way, for a comparison purpose, a video camera was manufactured in which a slot portion and a recording medium housing, both of which correspond to the slot portion 18 and the recording medium housing 17 in the embodiment according to the present invention, were combined firmly with each other by an epoxy adhesive. Then, the same drop test was carried out to measure an impact shock using this video camera for the comparison.

From the measurement results in the drop test, it has been found that the impact shock exerted on the cartridge 20 in the video camera for a comparison exceeds a permissible value of 200 G that is required for the cartridge 20 in operation, thereby possibly causing a damage on the cartridge 20, whilst the cartridge 20 in the video camera 500 experiences only an impact shock lower than 200 G in every one of the six tests, thereby being free of damage.

Referring to the above embodiment, the present invention has been disclosed. However, the present invention is not limited to the embodiment above and can be altered or modified without departing from the scope of the invention.

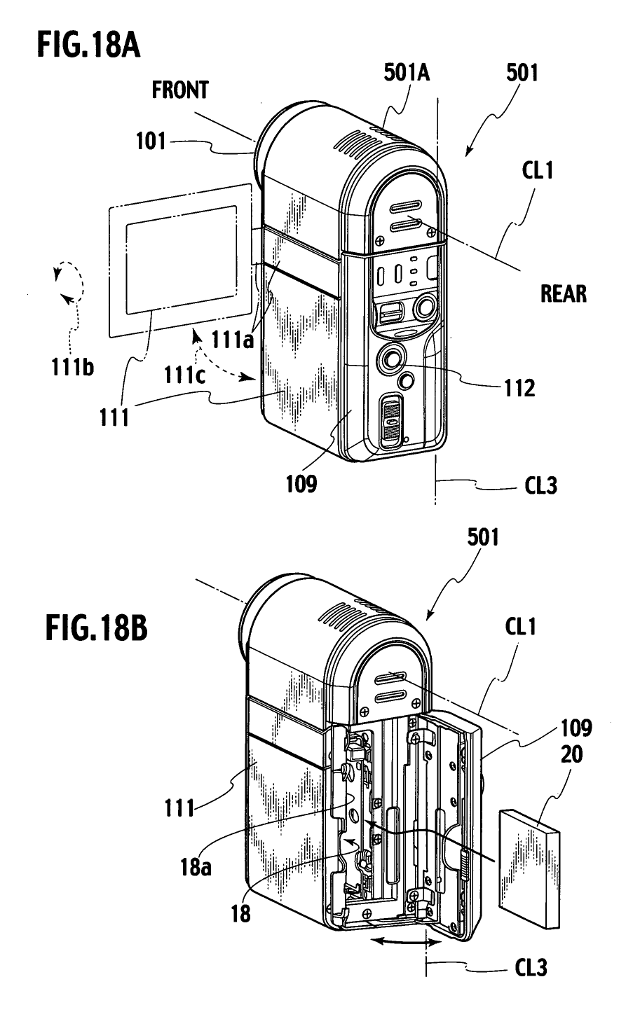

For example, although the cartridge is inserted downwardly into or removed upwardly from the slot portion in the video camera according to the above embodiment, the video camera can be configured so that the cartridge is inserted or removed from the rear face (the face facing a user of the camera), the configuration of which is illustrated in FIG. 18 as another embodiment. FIG. 18A illustrates a part of the video camera in which a hinge flip cover is closed. FIG. 18G illustrates a part of the video camera in which the cover is opened.

In FIG. 18A, the video camera 501 is comprised of a body 501A equipped with a zoom lens 101, an liquid crystal display 111, an operation button 112, and a hinge flip cover 109.

The hinge flip cover 109 has a pivot axis CL3 in a direction perpendicular to an optical axis CL1. FIG. 18A illustrates where the liquid crystal display 111 is retracted in the body 501A whereas the display 111 can be located as shown in FIG. 18A by a pivotal movement 11b, 111c thereof around a hinge portion 111a.

When the cover 109 is opened, a slot portion 18 disposed inside is seen. The cartridge 20 can be inserted into or removed from the opening portion 18a in a direction of the optical axis CL1.

Namely, the cartridge 20 has to move along the same direction of the optical axis CL1 at the time of insertion and removal, as is not the case with the above-stated embodiment in which the cartridge 20 moves in a direction different from the optical axis CL1.

The above embodiment and modifications describe the video camera into which the present invention is embodied. However, the present invention is embodied into any information processing appliance such as but not limited to a digital camera, a note-type personal computer, a document presenter, a portable music player, a personal digital assistance, a game console, a video player, and a disc recorder utilizing a Digital Versatile Device, a Bru-Ray disc or the like. In other words, the information processing appliance here means an apparatus that records or reads data on or from a recording medium.

In addition, the information processing appliance into which the present invention is embodied includes not only a carriageable appliance listed above but also a desktop type apparatus.

Moreover, whilst a hard disc is utilized as a recording medium built-in in a cartridge in the above embodiment, the medium is not limited to a hard disc but may be an optical disc or the like. In other words, the cartridge may house a driver that drives such discs.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing appliance in which a cartridge containing a recording medium can be inserted in or removed out through an opening provided in a body unit and thus information is recorded on or read from said recording medium inserted, said information processing appliance comprising:
a housing portion separably provided inside of said body unit, said housing portion housing said cartridge,
a first support member supporting said housing portion allowing for a first permissible amount in a relative position of said housing portion with respect to said body unit,
a second support member supporting said housing portion allowing for a second permissible amount or lower in a relative position of said housing portion with respect to said body unit, said second permissible amount being smaller than said first permissible amount, and
a switching mechanism switching between said first support member and said second support member to support said housing portion, thereby changing between said first permissible amount and said second permissible amount in said relative position.

2. An information processing appliance as recited in claim 1, wherein said first support member is a buffer member disposed between said housing portion and said body unit and wherein said second support member is a connection member joining said housing portion and said body unit restrictingly.

3. An information processing appliance as recited in claim 1, wherein said switching mechanism comprises a cartridge restricting member restricting an insertion/removal of said cartridge with respect to said opening when selecting said first support member.

4. An information processing appliance as recited in claim 1, further comprising:
an insertion/removal detector detecting an insertion/removal of said cartridge into/from said housing portion to output a signal accordingly, and
a controller controlling said switching mechanism based on the signal outputted from said insertion/removal detector.

5. An information processing appliance as recited in claim 3, wherein said cartridge restricting member is a cover that is openable and closable with respect to said opening.

6. An information processing appliance as recited in claim 2, wherein said buffer member has at least a pair of opposing faces, one face being attached on said housing portion and the other face being attached on said body unit so as to absorb forces exerted in a compression and a shear direction due to a relative movement between said housing portion and said body unit when the housing portion is supported by the first support member.

7. An information processing appliance as recited in claim 1, wherein said recording medium is a hard disc.
